(19) United States
(12) Patent Application Publication
(10) Pub. No.: US 2002/0046073 A1
(43) Pub. Date: Apr. 18, 2002

(54) CONFIGURABLE WEIGHTING OF REPRESENTATIONAL CONTROLS TO OBTAIN AN OPTIMAL ROUTING SOLUTION

(76) Inventors: RUNAR INDSETH, AUSTIN, TX (US); MARK T. LANE, FRANKLIN, TN (US); G. EDWARD POWELL, AUSTIN, TX (US)

Correspondence Address: HAYWARD A. VERDUN, GARY CARY WARE & FREIDENRICH, LLP, 100 CONGRESS AVENUE, SUITE 1440, AUSTIN, TX, 78701, US

(21) Appl. No.: 09/158,309

(22) Filed: Sep. 22, 1998

Related U.S. Application Data
(63) Continuation-in-part of application No. 09/087,828, filed on May 29, 1998, now abandoned.

(51) Int. Cl. G06F 17/60

(52) U.S. Cl. 705/8

(57) ABSTRACT

A method for delivering an optimal routing solution that considers the complete operational cost model in the optimization process is provided. The method utilizes heterogeneous service providers to service heterogeneous service points, where the service points are geographically dispersed. The method includes providing a plurality of service point profiles that define parameters associated with a plurality of service points; providing a plurality of service provider profiles, that define parameters associated with a plurality of service providers; providing a service point visit plan for the plurality of service points; and scoring a plurality of routing solutions to service the plurality of service points, utilizing the service point profiles and the service provider profiles. In addition, scoring controls are provided for assigning a cost to, or penalty, either linearly or non-linearly, selected parameters being either met or not met within any possible routing solution. The profiles, visit plan, and scoring controls are provided to a route engine that determines an optimal routing solution according to the scoring model.

### CROSS REFERENCE TO RELATED APPLICATION(S)

This application is a continuation-in-part of copending U.S. patent application, Ser. No. 09/087,828, filed May 29, 1998, entitled “REPRESENTATIONAL CONTROL FOR OPTIMAL ROUTING SOLUTION”, and assigned to a common Assignee.

### BACKGROUND OF THE INVENTION

1. Field of the Invention

This invention relates in general to the scheduling of resources to visit predefined service points, and more specifically to a weighting scheme within a computerized methodology for providing optimal routing solutions utilizing representational parameters for resources and service points.

2. Description of the Related Art

The routing and scheduling of vehicles, personnel, and/or services represents an important cost component for many service industries. The utility industry (electric, gas, water) , telephone and telecommunications industries, transportation industries (ground, air, water), mail and package delivery industries, courier services, and health care industry are all examples of businesses that have to schedule equipment or personnel to travel from one location to another, either to pick up or deliver people or packages, or to perform services, such as repairing a telephone or visiting a patient.

Typically, when calculating optimum routing solutions for a particular industry, the methodology has been restricted to optimizing routes for a set of service providers originating from a common depot location, utilizing geographical distance as the sole factor in determining an optimal route. That is, systems are given a set of service providers at a common depot location, and a list of service points at which a service provider must make an appearance. The systems then generate a routing solution for the set of service providers that is optimal to reduce either travel distance, or travel time. For purposes of obtaining an optimum solution with these systems, all of the service providers are considered to have the same capabilities or skills, and all of the service points are treated as the same. That is, the systems view service points and service providers as homogeneous sets.

In addition, many systems are unable to provide routing solutions with any consideration of time. For example, when scheduling a package pickup from a major transportation company, or a utility hook up with a local utility provider, it is often impossible to obtain a commitment with respect to an anticipated time of service. Rather, the routing solutions used by such companies only guarantee that a service will occur before closing of a particular business day.

More recent advances have been made which allow for inclusion of time windows as a parameter to be used in obtaining an optimal routing solution. A time window defines a start time, and an end time, between which service must be performed for a particular service point. One such solution is discussed in an article entitled “A New Optimization Algorithm for the Vehicle Routing Problem with Time Windows”, by Desrochers, Desrosiers & Solomon, Vol. 40, No. 2, pages 342-354, 1992 Operations Research Society of America, which is incorporated herein by reference. However, such solutions only use geographic distance, and time windows to obtain an optimal routing solution for a homogeneous set of service providers, departing from a common depot location, for servicing a homogeneous set of service points.

The above described solutions, although attempting to reduce service costs by reducing either the travel distance or the travel time for a particular set of routes, have not proven satisfactory for industries having multiple depot locations, or industries using a heterogeneous set of service providers to service a heterogeneous set of service points.

For example, in the home health care industry, the skill set of a service provider must be correlated to the type of service required by a patient. One nurse may have the skill, and the necessary license, to redress a wound, or draw blood, but may not have been trained to insert a catheter. If that type of service is required by a patient, it would be inappropriate, and costly, to schedule a nurse without the appropriate skill level to visit that patient. Furthermore, particularly in the health care industry, time may be of the essence. If a patient requires an insulin injection between the hours of 7-9 am every day, it would be disastrous to have a routing solution that caused a nurse to arrive at 12 pm.

Modern methodologies have simply failed to deal with the problem of optimizing routes for a set of service providers, each of which have unique skills, perhaps departing from geographically distinct service points, that service a set of heterogeneous service points, also geographically dispersed.

Therefore, a methodology is needed that provides a routing solution that considers any of a number of selected parameters, such as the skills of the service providers, the needs of the service points, the preferences of both the service providers and the service points, in determining an optimum solution.

In addition, a methodology is needed for optimizing routing solutions for heterogeneous service points, using heterogeneous service providers, where each of the parameters used in obtaining the routing solution (e.g., skills, licenses, preferences) is individually configurable, both in terms of whether they are considered in obtaining the routing solution, and in terms of how much weight is applied to them in obtaining a routing solution.

For example, in the instance mentioned above where a patient requires an insulin injection between the hours of 7-9 am every day, while it would be disastrous to schedule a visit at 12 pm, it may be possible to schedule a visit at say 7:30 am. Another example would be if the service provider available to make the insulin visit did not desire to work before 12 pm, or was already on overtime before making the insulin visit. Certain costs should be considered before selecting that provider for that visit. And, depending on the providers window of availability, and his/her accumulated hours for the week, the weighting applied to their cost could be non-linear. What is therefore needed is a routing system that allows linear and non-linear penalty to be applied to particular parameters, that result in a total optimal solution.

### SUMMARY

To address the above-detailed deficiencies, it is an object of the present invention to provide a method for delivering an optimal routing solution that allows both linear and non-linear penalty to be applied to selected parameters in determining the complete operational cost of a routing solution.

Yet another object of the present invention is to provide a method for obtaining an optimal routing solution that considers the total costs associated with any particular route, including configurable weighting of a skill or license requirement not being met, a preference being met or not met, as well as a number of other parameters.

It is therefore a feature of the present invention to provide a method for calculating an optimal routing solution given a plurality of service points and a plurality of service providers, the plurality of service providers having a plurality of parameters that are selectably weighted. The method includes: selecting at least one of the plurality of parameters to weight; specifying a weight to be applied to the selected at least one of the plurality of parameters; and scoring a plurality of routing solutions utilizing the specified weight applied to the at least one of the plurality of parameters.

An advantage of the present invention is that an operator can configure a penalty scheme of direct or indirect costs to be applied to any parameter used in obtaining an optimum routing solution.

In another aspect, it is a feature of the present invention to provide a method for scheduling routes using heterogeneous service providers to service heterogeneous service points, the service points being geographically dispersed, the service points having a plurality of service point profiles, and the service providers having a plurality of service provider profiles. The method includes: providing a service point visit plan for at least one of the plurality of service points; specifying a configurable weight to be applied to a selectable parameter within one of the plurality of service provider profiles; and scoring a plurality of routing solutions to service the at least one of the plurality of service points, utilizing the service point profiles, the service provider profiles, and the weighted selectable parameter; wherein an optimal routing solution is obtained from the scored plurality of routing solutions.

### BRIEF DESCRIPTION OF THE DRAWINGS

These and other objects, features, and advantages of the present invention will become better understood with regard to the following description, and accompanying drawings where:

FIG. 1 is a pictorial representation of a city map illustrating a plurality of service points that are geographically dispersed that must be serviced by a plurality of service providers.

FIG. 2 is a pictorial representation of a sub-optimum routing solution for servicing a plurality of homogeneous service points.

FIG. 3 is a pictorial representation of an optimal routing solution for servicing a plurality of homogeneous service points.

FIG. 4 is a block diagram illustrating components within an embodiment of the present invention.

FIG. 5 is a computer screen illustrating an operations manager according to the present invention.

FIG. 6 is a computer screen illustrating general information associated with a service provider according to the present invention.

FIG. 7 is a computer screen illustrating particular details associated with defining a service provider according to the present invention.

FIG. 8 is a computer screen illustrating particular skills associated with a service provider in the health care industry according to the present invention.

FIG. 9 is a computer screen illustrating a service provider's work availability for a particular week according to the present invention.

FIG. 10 is a computer screen illustrating general information associated with a service point according to the present invention.

FIG. 11 is a computer screen illustrating preferences of a service point according to the present invention.

FIG. 12 is a computer screen illustrating definition of a visit plan for a particular service point, according to the present invention.

FIG. 13 is a computer screen illustrating relational definitions between skills and tasks within the health care industry, according to the present invention.

FIG. 14 is a computer screen illustrating router controls and scoring controls for obtaining an optimal routing solution, according to the present invention.

FIG. 15 is a graph illustrating a procedure for specifying linear and non-linear penalty to be applied to selected parameters within service provider and service point profiles.

FIG. 16 is a flow chart illustrating a procedure according to the present invention for obtaining an optimal routing solution for a given set of service providers, and a given set of service points, using a predetermined visit plan.

### DETAILED DESCRIPTION

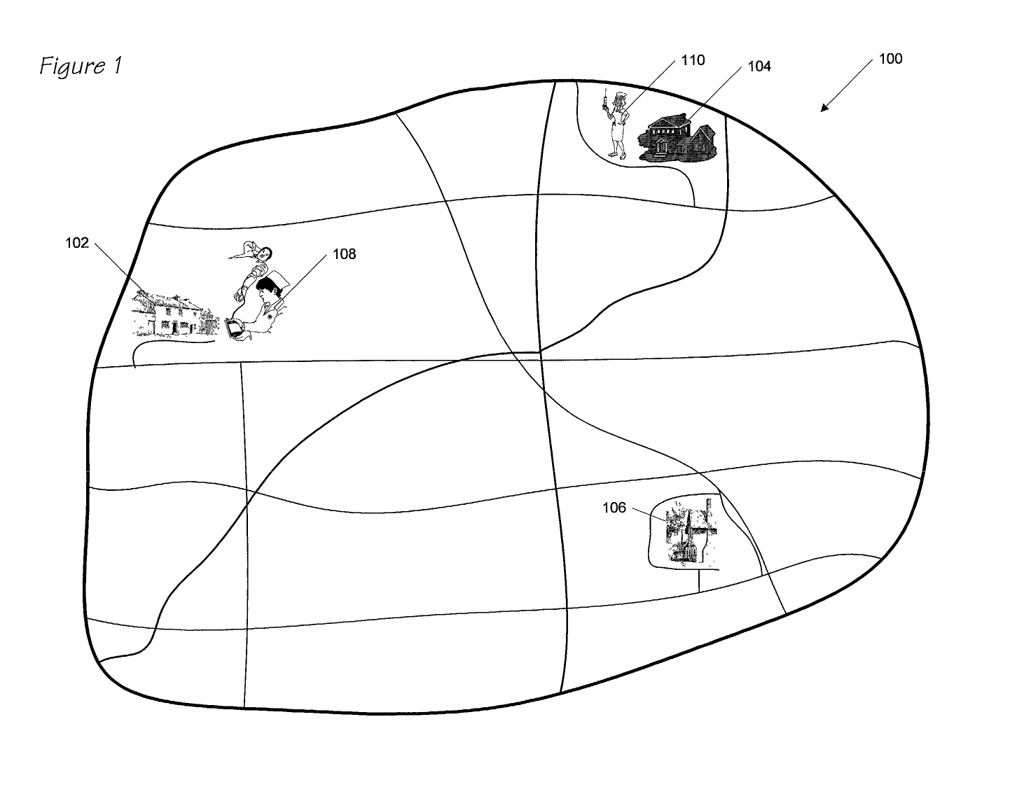

Referring to FIG. 1, a map 100 is shown. The map 100 illustrates a portion of a city having residences 102, 104 and 106 that are geographically dispersed. The residences 102-106 are defined by their longitude and latitude, and are associated with street addresses, or other forms of reference, within the map 100.

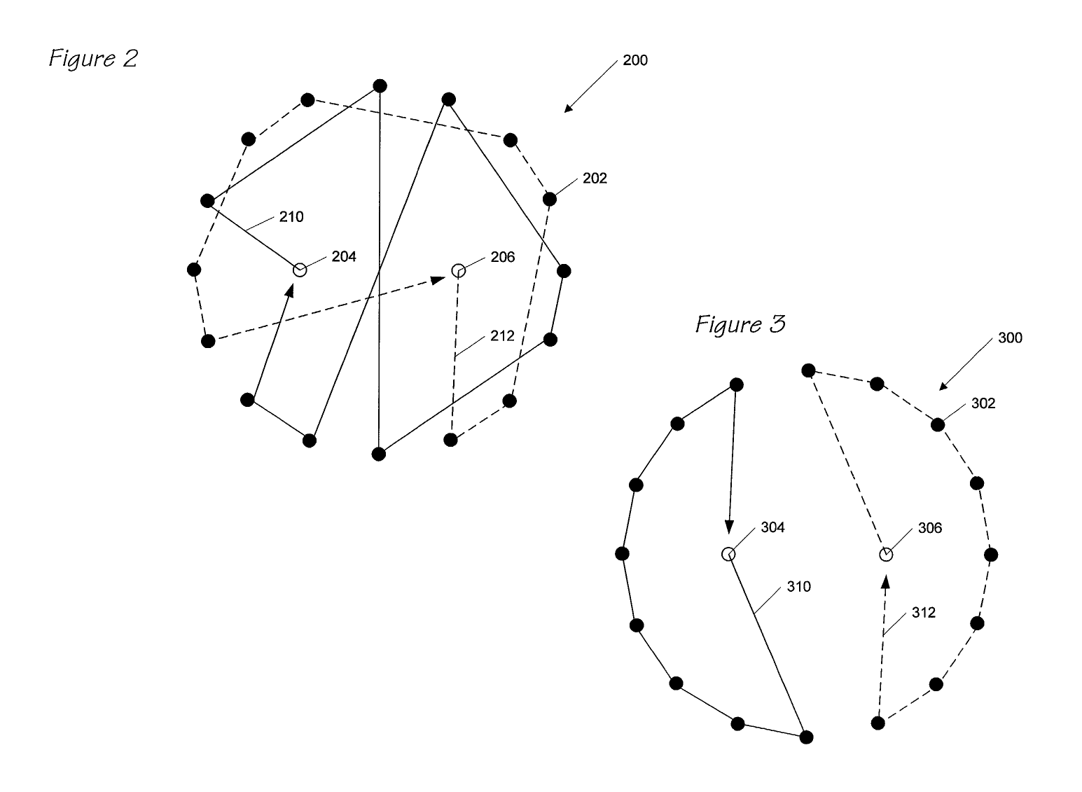

Also shown on the map 100 are health care providers 108 and 110, located at the residences 102 and 104, respectively. The health care providers 108, 110 are providing in home health care services to patients living at the residences 102, 104. Also shown is a third residence 106. Health care services at this residence are to be performed by either the provider 108, or the provider 110. The routing of the providers 108, 110 to the residences 102, 104, and subsequently to the residence 106 must consider parameters such as: 1) the type of service required by the patient, 2) the skills required to perform the service, 3) the current license status of the providers 108, 110, 4) the preferences of the patient at the residence 106, 5) the preferences of the providers 108, 110, 6) the materials required to perform the service, and 7) the availability of the providers 108, 110 within a time frame required by the patient. However, heretofore such routing of providers only considered the distance that had to be traversed by a particular provider, and possibly the timeframe in which a service had to be performed. The parameters such as skills, licenses, preferences, and materials have either been ignored, or the routing solutions used have not been optimal. An example of a sub optimum routing solution is shown in FIG. 2, to which attention is now directed.

In FIG. 2, a map 200 is shown having 16 homogenous service points 202 that are to be serviced by two homogenous service providers 204 and 206. Homogenous service points and service providers imply that the services required by any of the service points 202 are identical, and that either of the service providers 204, 206 are capable of servicing any of the service points 202.

For purposes of illustration, the service providers 204 and 206 begin their routes at geographically distinct locations, and upon completion of their routes, return to their originating location. If it is presumed that none of the service points 202 have time windows during which service must be provided, that the service providers 204, 206 are available at the same time, and that both service providers 204, 206 are capable of servicing eight service points in a day, one routing solution for the service providers is shown by routes 210 and 212.

What should be clear from the map 200 is that both of the routes 210, 212 include legs (travel between two service points) that are of considerable distance. One skilled in the art should recognize that these distances are sub optimal because they require the service providers 204, 206 to spend too much time traveling between the service points 202. In general, the service providers 204, 206 are either employees of a service company, or are contractors hired by a service company. In either case, a service company is primarily concerned with providing service to the greatest number of patients, in the least amount of time, so as to reduce their overall operating expenses. If either of the service providers 204, 206 make poor choices in their route, or are provided with sub optimum routes, valuable time and considerable expense is wasted.

Now referring to FIG. 3, a map 300 is shown. The map 300 contains 16 homogeneous service points to be serviced by two service providers 304, 306. A routing solution is shown that provides two routes 310, 312 for the service providers 304, 306, respectively. However, in FIG. 3, the routes 310, 312 are optimal to reduce the amount of time the service providers 304, 306 spend traveling between the service points 302. One skilled in the art will appreciate that the routing solution provided in FIG. 3 is optimal over that of FIG. 2 to reduce many of the operating costs associated with servicing the service points, and ultimately to increase revenue for the service company.

Generally, service companies have operating costs that include travel time, gasoline and other transportation expenses, and hourly wages for the service providers. In addition, with less time spent traveling between service points, it is possible that the service providers 304, 306 could service more than the eight service points 302 shown, thereby creating further revenue for their service company.

However, as explained in the Background above, route optimization methodologies have heretofore been concerned with servicing a set of homogeneous service points using homogeneous providers. Such methodologies have failed to deal with industries requiring route optimization of service providers, each of which have unique skills or licenses, or of heterogeneous service points, each requiring a different service or skill level, or allowing service points to state preferences regarding the provider, or the desired time of service, etc. As a result, service companies have forgone analyzing route solutions based on a total route cost model. That is, a route cost model that considers direct costs such as wages (salary, hourly, overtime, etc.) and transportation expenses, as well as real but indirect costs, such as skill deficiencies, unmet preferences, servicing outside of time windows, etc. Instead, they have either derived a routing solution based solely on geographic distance, perhaps including time windows, or have treated service providers and service points homogeneously. In some instances, service companies have neglected route optimization altogether.

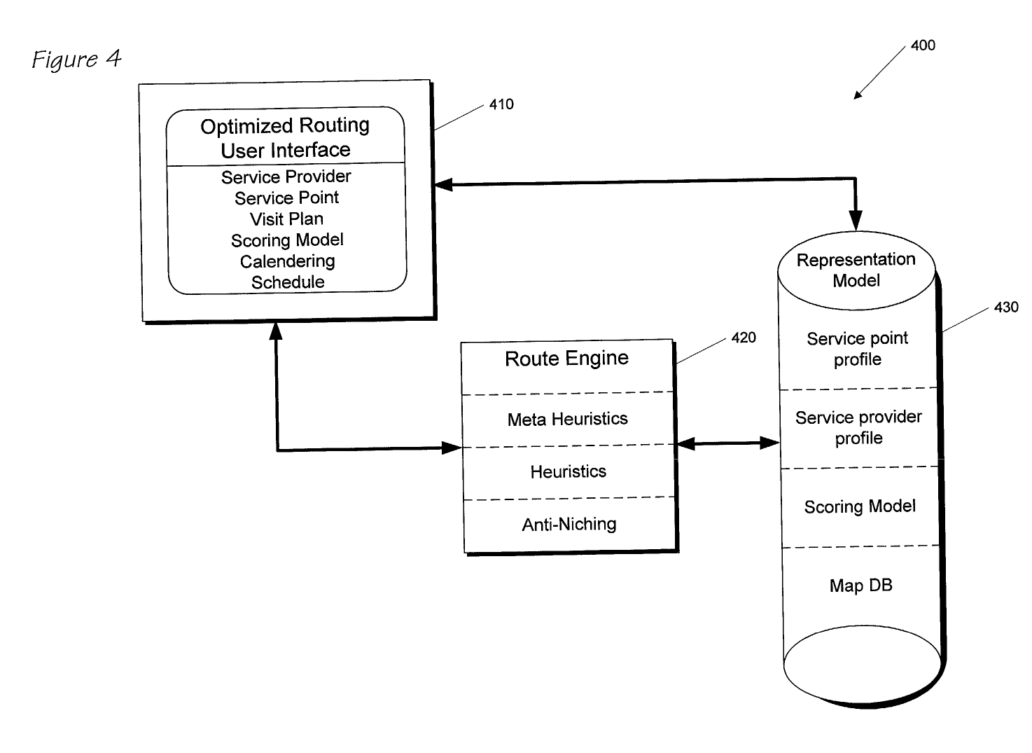

What will now be described is an embodiment of the present invention that provides an optimal routing solution for industries having heterogeneous service providers that service a heterogeneous set of service points. Referring to FIG. 4, a block diagram 400 is shown illustrating an embodiment of the present invention. The invention includes an operator interface 410 coupled to a route engine 420 and a representation model 430.

The user interface 410 provides a computer mechanism for inputting all of the information associated with determining an optimal routing solution for a given set of service providers and service points, and for displaying and analyzing resultant routing solutions.

The user interface 410 is coupled to a representation model 430 which stores the data required for determining an optimal routing solution for a particular visit plan (further described below). The representation model 430 includes a service point profile, a service provider profile, a scoring model, information on time windows associated with a particular visit plan, preferences for both service providers and service points, and a map database for a particular service area. Information is input into the representation model 430 via the user interface 410.

The representation model 430 is coupled to a route engine 420. The route engine 420 implements one of a number of alternative algorithms for deriving an optimal routing solution, given a set of service providers and a set of service points. One skilled in the art will appreciate that the use of meta-heuristics to breed a set of solutions is known. However, meta-heuristics tend to be slow, and often engage valuable processing time “breeding” less than optimal solutions. Heuristics, on the other hand, tend to provide solutions in a more expedient manner, but fail to search broadly the multimodal graph. The route engine 420 therefore combines the use of meta-heuristics, which are robust but slow and have no clear stopping rules, with heuristics, which are fast but not exhaustive, to obtain a generation of possible solutions. Within each generation, however, a number of less than desirable possibilities are created. The route engine 420 therefore uses a technology termed “anti-niching” to essentially prevent premature convergence. The combination then of meta-heuristics, with heuristics and anti-niching techniques, to produce an optimal routing solution in an expedient manner is fully described in U.S. patent application, Ser. No.______ (Docket EPI:1003), filed______, entitled “Multi-layer Engine Using Generic Controls for Optimal Routing Scheme”, by Mark T. Lane, Ph. D., et al., which is hereby incorporated by reference. One skilled in the art will appreciate however, that an optimum routing solution for a set of heterogeneous service providers, given a set of heterogeneous service points, may be accomplished using any of a number of known routing methodologies in combination with the teachings of the present invention.

Once the route engine 420 has calculated an optimal routing solution, using the data in the representation model 430, the solution is provided to the user interface 410. At this point, the user interface can either deliver individualized routes to a set of service providers, or can provide a graphical overview of the routing solution to allow an operator to modify the solution, as desired.

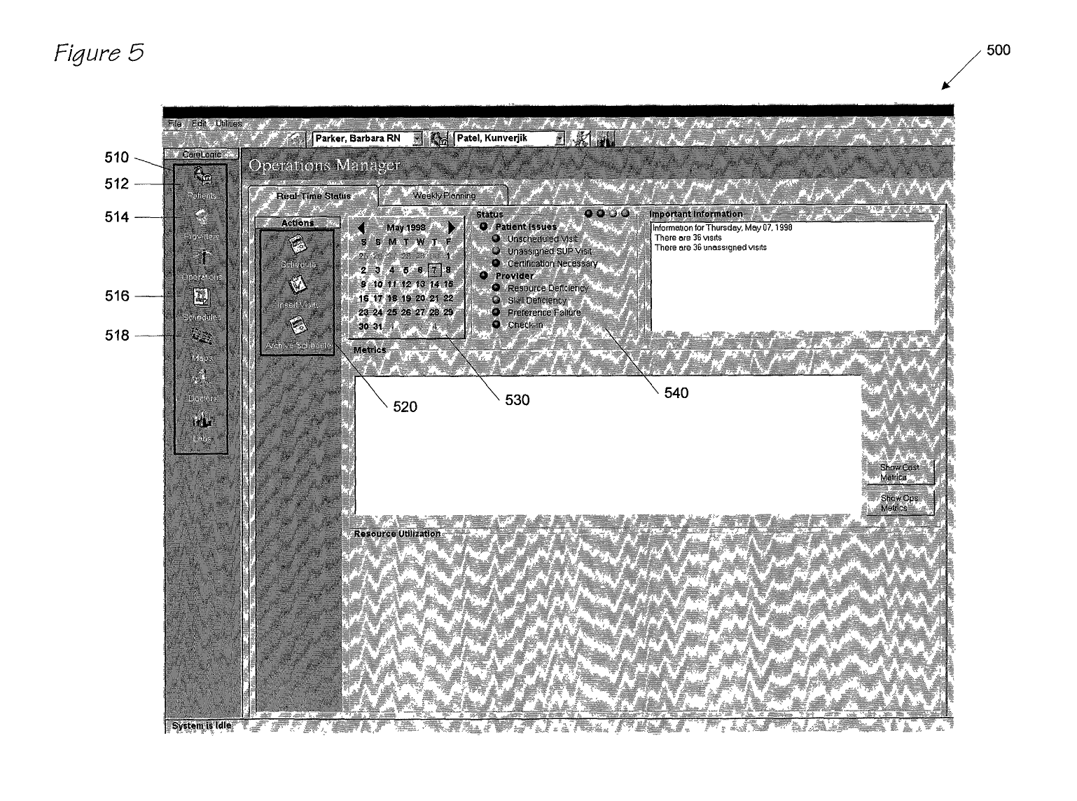

Now referring to FIG. 5, a screen shot is provided of an operations manager portion 500 of the user interface 410. The operations manager 500 includes a Navigation bar 510, an Actions icon set 520, a Calendar 530, and a Status box 540. The Navigation bar 510 allows an operator to select one of a number of display screens, corresponding to service points (patients) 512, service providers (providers) 514, service provider schedules (schedules) 516, or area maps 518. The Actions icon set 520 allows an operator to initiate the generation of a routing solution (schedule), to insert a visit in a least cost manner, within the existing service provider's schedules (Insert Visits), or to archive a previously generated schedule (Archive Schedule), by pressing an appropriate icon. The Calendar 530 allows a user to select a particular day, or week, for which a routing solution will be generated.

The Status box 540 provides the user with information regarding the status of service points and service providers for the day selected on the calendar 530. In one embodiment, the Status box 540 alerts the user of patient issues including: unscheduled visits, unassigned supervisor visits, and certification necessary. A “light” in a graphical LED next to unscheduled visits indicates that a visit has been scheduled in a visit plan for a particular service point, which has not yet had a service provider assigned to it. A light next to unassigned supervisor visit indicates that a service provider may have been assigned to visit a service point, but that the assigned service provider requires supervision, and a supervisor has not yet been assigned. This is particularly important in the health care industry where certain providers can perform some tasks independently, such as bathing a patient, redressing a wound, or giving a shot, but are in training when performing other tasks such as taking blood or inserting a catheter. A light next to certification necessary indicates that although a service provider has been scheduled to visit a service point, the assigned service provider does not have the license, or certification necessary to perform the required services.

The Status box 540 also includes information with respect to service providers for the day selected in the calendar 530. The information includes: resource deficiency, skill deficiency, and preference failure. A light next to resource deficiency indicates that there are too many service points to be visited by the available set of service providers. An alert in this area would cause the user to either contract with an additional service provider, or possibly reschedule one or more of the visits for another day. A highlight next to skill deficiency indicates that although all of the service points have a service provider scheduled to visit them, one of the scheduled service providers does not have either the skills, or the certification necessary to perform the required service. A light next to preference failure indicates that although visits may have been scheduled to all service points, particular preferences, either of a service point or a service provider, may not have been met. Alerts on any of these status indicators may cause an operator to develop an alternative visit plan, and generate another route solution, or contact an additional service provider to overcome any deficiency.

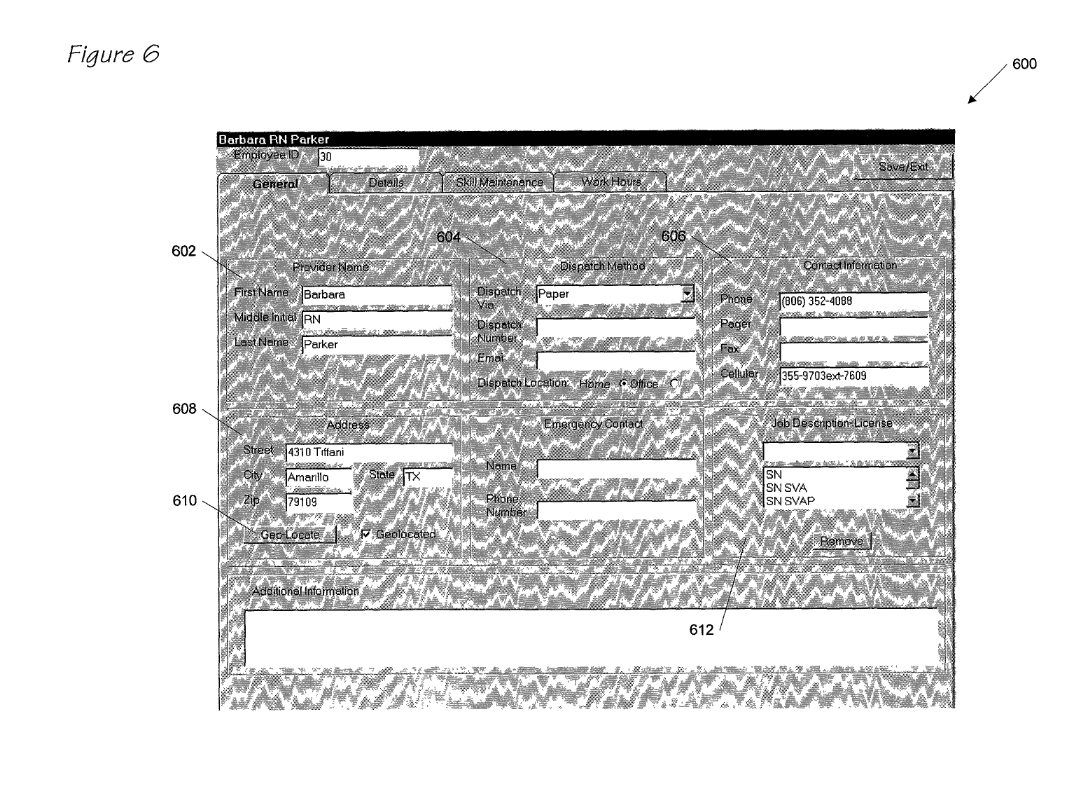

Now referring to FIG. 6, a screen shot 600 is shown associated with inputting general information respecting a service provider. In one embodiment, the screen 600 is presented when an operator selects I/O icon 514 on the operations manager 500. The screen shot 600 has 4 tabs at the top denoted: General, Details, Skill Maintenance and Work Hours. Each of these will be described below with reference to FIGS. 6-9. The screen shot 600 includes fields for a provider name 602, a dispatch method 604, contact information 606, an address 608, and job description-license 612. The provider name field 602 allows an operator to maintain the name of a service provider. The dispatch method field 604 defines how the service provider is to be contacted for scheduling purposes. In one embodiment, the service provider can be contacted by mail, by fax, by email, or simply by handing him/her a schedule at a designated location. The contact information field 606 provides telephone contact information for the provider. The address field 608 provides street address information associated with the residence of the service provider. This is particularly important when generating an optimal routing solution if the service provider begins or ends his/her route from his/her home address. A geolocate button 610 is provided within the address field 608 to calculate an electronic position index, such as latitude, longitude, and street segment, etc., on the electronic map used in generating the routing solution. The job description-license field 612 particularly identifies the skills and the licenses held by the service provider. In one embodiment, fields 602-606 are used primarily by the user interface 410 in generating reports associated with service providers, while fields 608-612 are used primarily by the route engine 420 in calculating an optimal routing solution, as will be further described below.

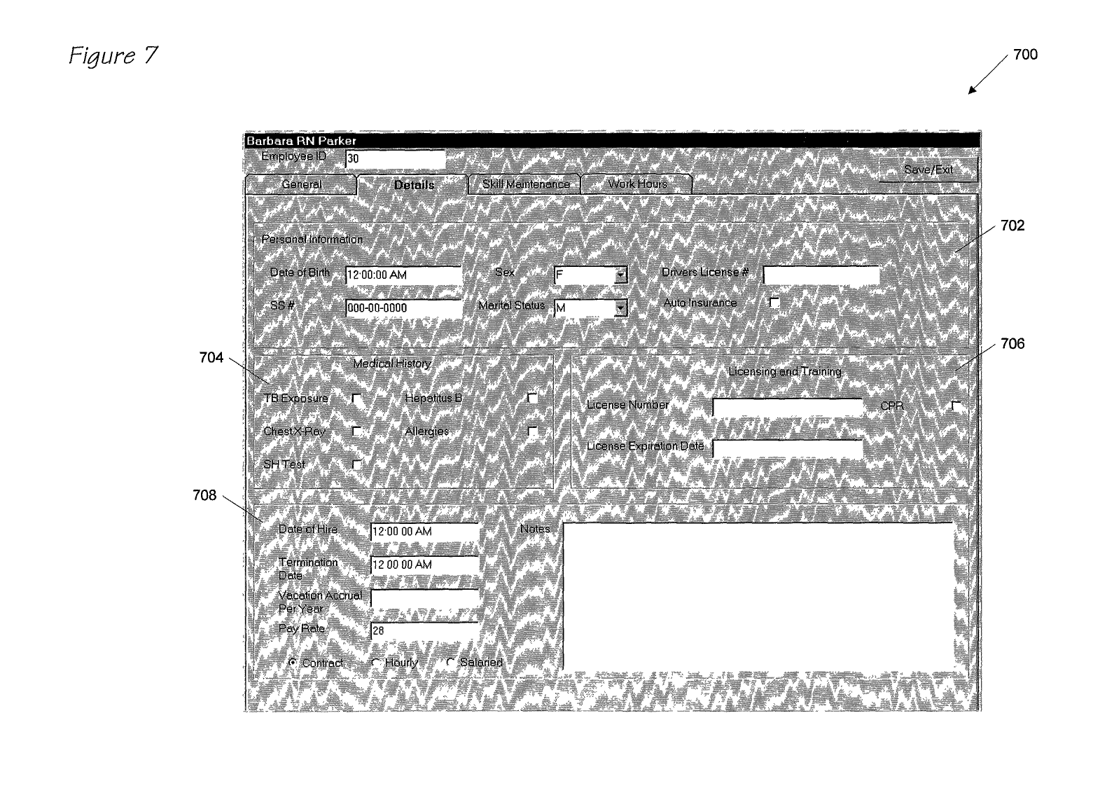

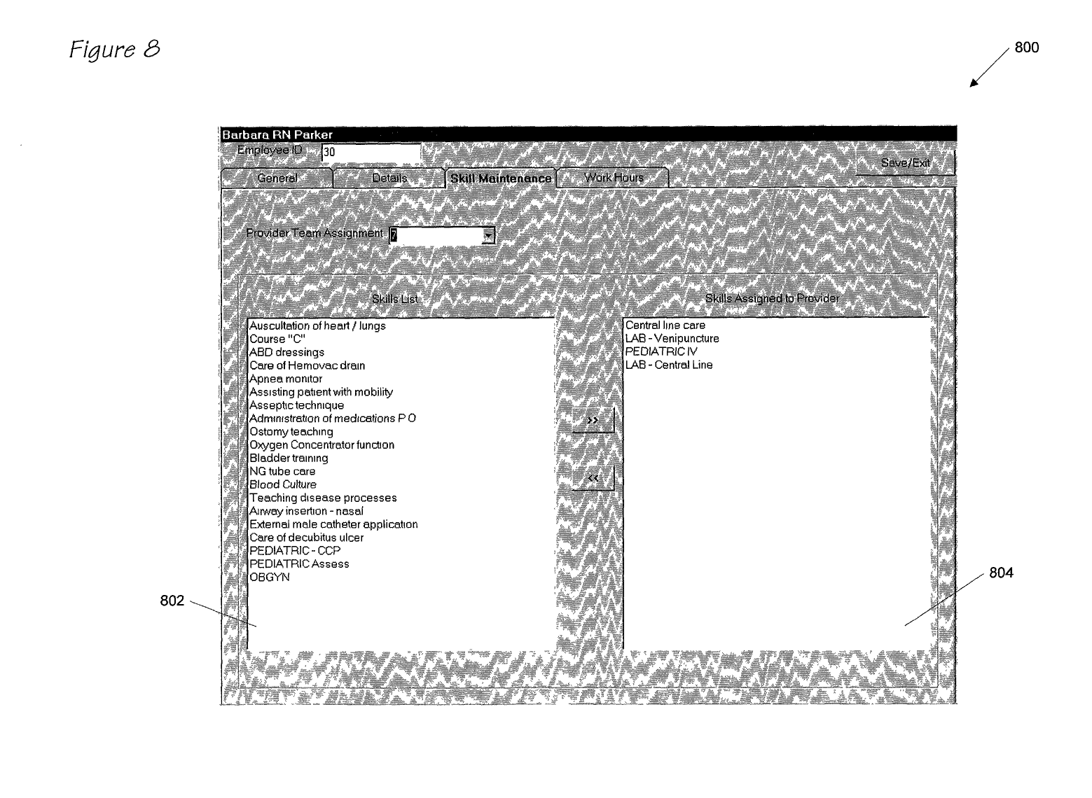

Referring now to FIG. 7, a screen shot 700 is shown which includes further details on the service provider that was input in FIG. 6. The fields shown in FIG. 7 include personal information 702, medical history 704, licensing and training 706, and employment information 708. The personal information field 702 may be used for employment and tax reporting, but can also provide driving/insurance information to insure the legality of scheduling a particular service provider to drive a route. The medical history field 704 can be used to maintain the health status of the service providers. The licensing and training field 706 may be used to track the existence or the status of a required license for performing particular services. The employment information field 708 includes information such as the pay rate of a service provider, and whether the service provider is an independent contractor, or an hourly or salary employee.

Referring now to FIG. 8, a screen shot 800 is shown that defines the skills obtained by a particular service provider. The screen 800 includes a skills list 802 and a skills assigned field 804. The skills list 802 contains a listing of all the skills for a particular industry which must be individually tracked. The skills listed in field 802 are a representative subset of skills required in the home health care industry. It should be appreciated that other industries have different sets of skills which must be tracked for their service providers. The skills assigned field 804 define the skills obtained by the particular service provider for which information is being input.

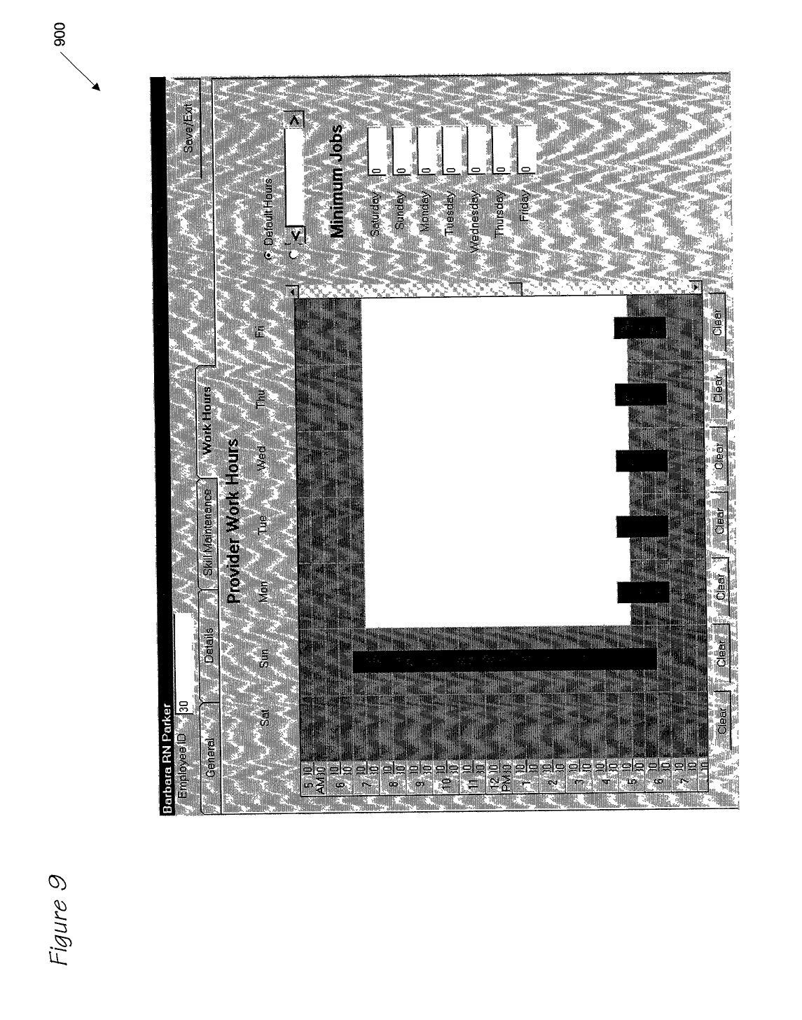

Referring now to FIG. 9, a screen shot 900 is shown which illustrates the work hours associated with a particular service provider. In one embodiment, the screen 900 provides a week at a glance format indicating the availability of a particular service provider to perform services to scheduled service points.

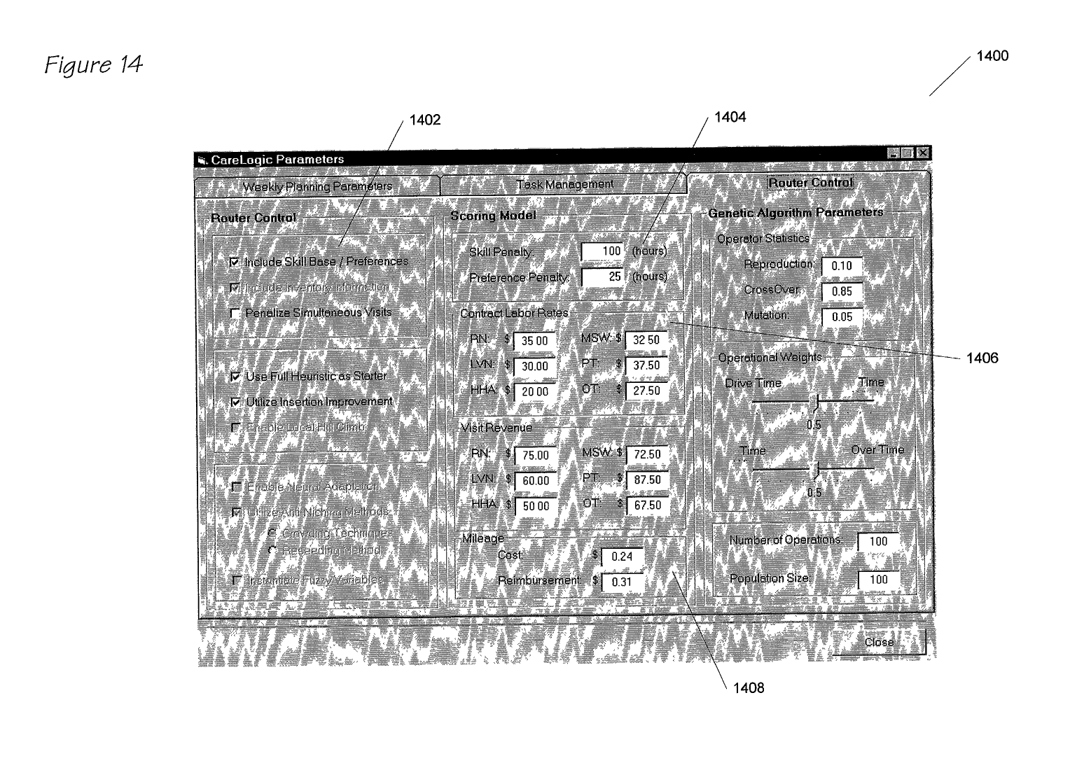

The information shown in the screens 600-900 provide the information necessary to utilize a service provider within a routing solution. As will be further described below, with reference to FIG. 14, selected fields within screens 600-900 may be used by the route engine 410 in deriving an optimal routing solution. These fields include a service provider's availability, their assigned skills, their licensing information, their employment information (such as their pay rate), their job description-license (including the minimum number of service points per day that they require), and even their home address. Any one or more of the fields used to obtain an optimal routing solution is defined as a service provider profile.

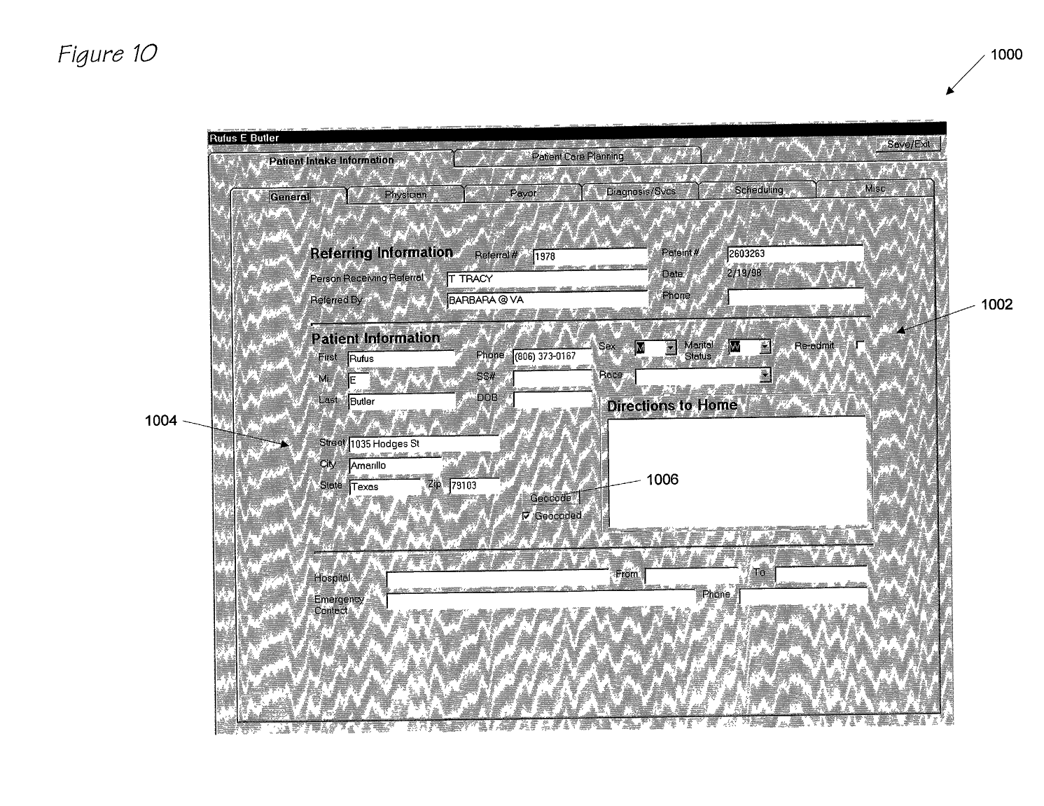

Referring now to FIG. 10, a screen shot 1000 for defining parameters of a service point is shown. Within the home health care industry, service points are referred to as patients. A patient information field 1002 is provided to input general patient information such as their name, social security number, etc. In addition, a patient address field 1004 is provided to define a street address where services are to be administered. Within the address field 1004 is a geocode button 1006 to cause the street address of the patient to be electronically indexed on an electronic map. The electronic index is then used in determining a routing solution to the patient.

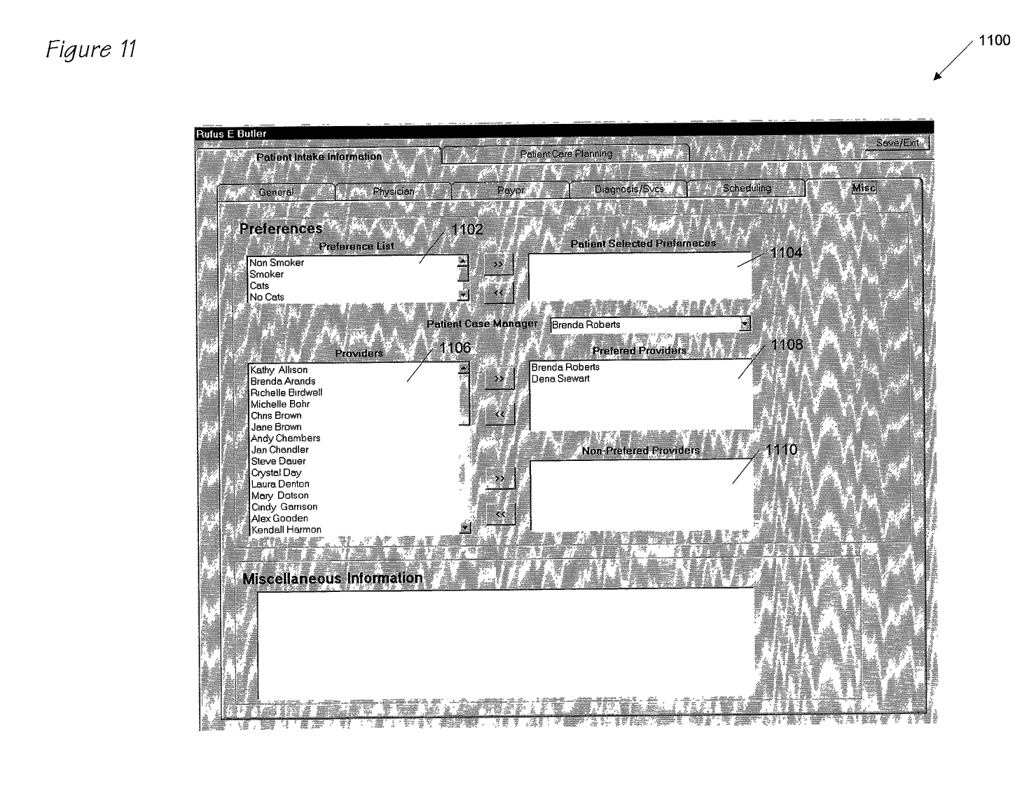

Referring now to FIG. 11, a screen shot 1100 is shown which allows preferences to be defined for a particular service point. The screen 1100 includes a preference list 1102, a patient selected preferences list 1104, a providers list 1106, a preferred providers list 1108, and a non-preferred providers list 1110. The preferences list 1102 contains a list of all available preferences that may be applicable to any service point. From the list 1102, particular preferences may be selected to apply to an individual service point. The selected preferences will then appear in the patient preferences list 1104. A list of all possible service providers is provided in list 1106 from which preferred and non-preferred service providers may be selected. The preferred providers for a particular service point will appear in list 1108, while the non-preferred providers will appear in list 1110.

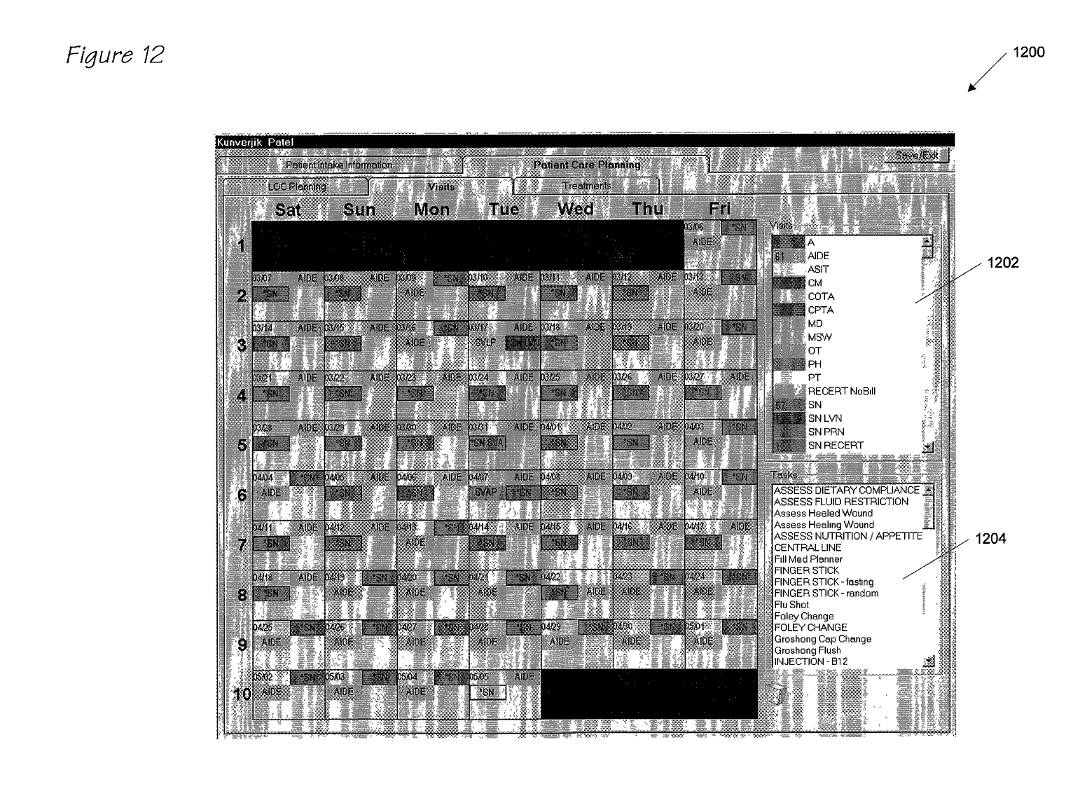

Referring now to FIG. 12, a screen shot 1200 is shown for developing a visit plan for a particular service point. In one embodiment, the screen 1200 includes a 10 week calendar for defining services to be performed for the service point. A service visit is created by selecting a visit type from a visit type list 1202, and dropping the visit type onto the day, or series of days requiring service. The visit types correspond to the type of service provider that is required by the particular service point. For example, in FIG. 6, a job description-license field 612 is provided to associate predefined license types to a particular service provider. In FIG. 1200, those license types are instantiated onto a particular day, or series of days to qualify the type of service provider that is required. Additionally, the particular tasks that must be performed on a particular day are selected from a task list 1204, and dropped onto the instantiated visit type. Thus, by instantiating a visit type, and a task on a particular day, an operator can define both the type of service provider that is required (i.e., the license that the service provider must hold to perform the service), and the tasks to be performed at the service point.

The information shown in the screens 1000-1200 provide the information necessary to utilize a service point within a routing solution. As will be further described below, with reference to FIG. 14, selected fields within screens 1000-1200 may be used by the route engine 410 in deriving an optimal routing solution. These fields include the service point address, service point preferences, and service point selected and non-selected providers. Any one or more of the fields used to obtain an optimal routing solution is defined as a service point profile.

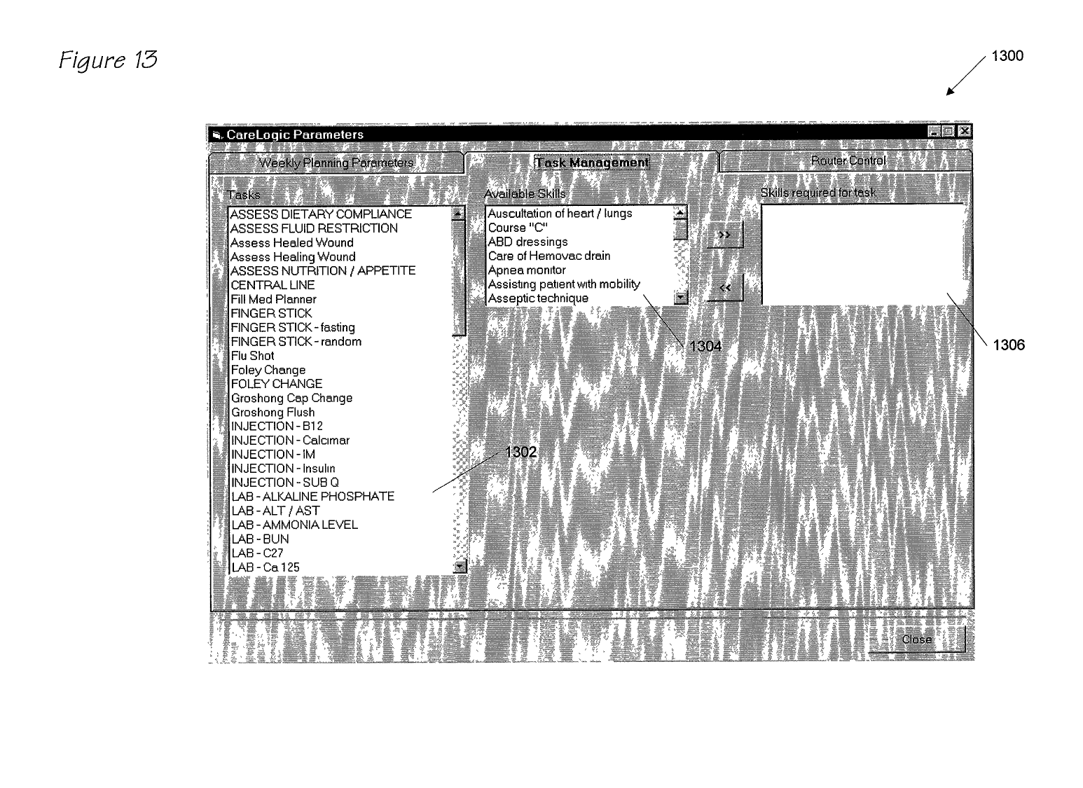

Referring now to FIG. 13, a screen shot 1300 is shown where relationships are established between required tasks to be performed, and the set of skills required to perform the tasks. More specifically, screen 1300 includes a task list 1302, a skill list 1304, and a skills required for a task list 1306. For each task in the task list 1302, one or more of the skills listed in the skill list 1304 must be selected. The task list 1302 corresponds to the tasks or services that may be selected in the visit plan shown in FIG. 12. The skill list 1304 corresponds to the list of skills obtained by a service provider, as defined above in FIG. 8. By associating skills required for a particular task within FIG. 1300, a relationship is created between services to be performed at service points, and a set of service providers that have obtained the skills necessary to perform those services.

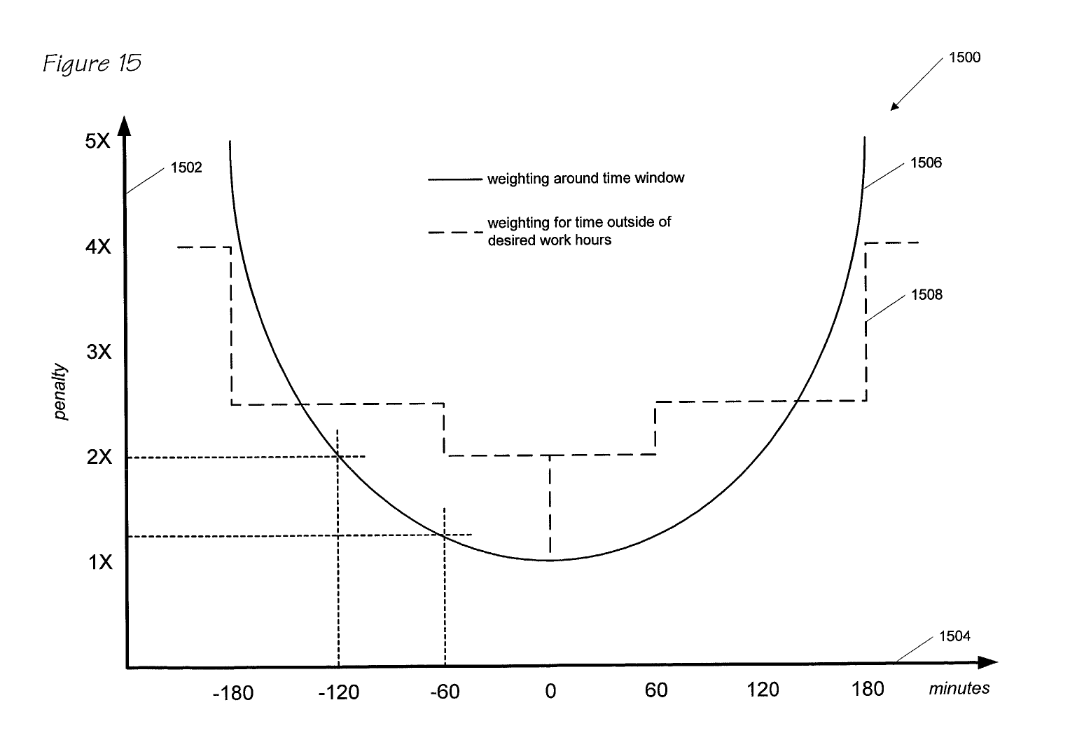

The above discussion of FIGS. 5-13 provides all of the information necessary to define a service provider profile for a heterogeneous set of service providers (having different skills, preferences, originating locations, licenses, etc.), and a service point profile for a heterogeneous set of service points (having different locations, different service type requirements, different license and skill requirements, different preferences, etc.) This information is stored within the representation model 430 to be used in obtaining an optimal routing solution, as will now be described below, with reference to FIGS. 14-15.

Referring to FIG. 14, a screen shot 1400 is provided to illustrate some of the controls that may be used in obtaining an optimum routing solution. Within a router control field 1402 are two options available for driving a router solution. The first control, “Include skill base/preferences”, is a binary control that when selected, generates routing possibilities using the skills/licenses, preferences parameters that were defined in FIGS. 5-12. A second control, “Penalize simultaneous visits”, causes the route engine to penalize a routing solution that has two service providers overlap their services at a common service point.

Also within FIG. 14 is a penalty field 1404. The penalty field 1404 allows an operator to create a penalty to be applied to either a skill deficiency, or a preference penalty. That is, for possible route solutions that do not contain the appropriate skill level for the service required, or is not able to comply with preferences specified by a service point, a negative penalty is applied to those routes.

Also shown within FIG. 14 are contract labor rate fields 1406. These fields allow an operator to associate real costs with using outside contractors to perform particular services. These costs, along with the salary wages defined for employed service providers, are factored into all possible routing solutions, so that a least cost solution can be obtained.

Finally, a mileage field 1408 is provided. The mileage field 1408 allows an operator to create a cost penalty to all distances driven in any possible routing solution.

Thus, FIG. 14 allows a user to score a routing solution by assigning costs or weights to routing solutions using a number of different parameters. The parameters include: skills being met or not met; preferences being met or not met, simultaneous visits scheduled; and mileage cost.

Furthermore, although skills base and preferences were treated together in field 1402, one skilled in the art should appreciate that any of the parameters associated with scoring a routing solution may be treated individually. In addition, both linear and non-linear penalty may be selectively applied to some parameters such as time windows.

While not shown in FIG. 14, the present invention employs a technique of converting each of the parameters in the service provider profile, and the service point profile into a direct cost or an opportunity cost for not being met. This means that there is a cost associated with: reimbursing a service provider for drive distance; not making a service point time window; not meeting a license requirement; not meeting a skill requirement; not meeting a service preference; not having the materials required to meet a service point need; not meeting a requirement for simultaneous service providers at a service point (such as when supervision is required); not starting or completing a service within a service provider's allocated work hours; paying a salary employee versus an hourly employee versus a contractor; interrupting a route to refill inventory, etc. By applying a direct, or indirect cost to each of the parameters being met or not met, a complete operational cost model may be used by the route engine 420 in the optimization process.

In addition, while not shown in FIG. 14, the present invention allows non-linear equations to be used in the penalty or costing of any of the specified parameters. For example, in determining a routing solution, it may be advantageous to pay a contractor to work an hour past his/her regularly scheduled time in order to complete a possible routing solution. A weight or cost of 1.5× hourly wage may be applied to that hour. However, if that same contractor is used an additional hour, a weight or cost of 6.0× hourly wage may be applied.

Another example where non-linear weighting may be advantageous is in scoring the parameter of meeting or not meeting a particular time window. For example, if a service point has a time window of 10 am-12 pm wherein service must be provided, a penalty of 0 should be applied to a solution that meets that time window. A small penalty may be applied to a routing solution that has the service provider arriving either 15 minutes early, or 15 minutes late. However, a fairly severe penalty would be applicable for a routing solution that has the service provider arriving an hour on either side of the time window. In addition, the early and late penalties can be configured differently. For example, if the provider arrives early, s/he can always wait for the begin time. But if s/he arrives late, the customer satisfaction level drops and may therefore be considered in the optimization.

One technique for allowing a user to specify both linear and non-linear penalty of selected parameters is shown in FIG. 15, to which attention is now directed. FIG. 15 provides a graph 1500 where a cost multiplier is represented on a Y-axis 1502, and time variation from either a time window, or from desired work hours, or overtime, is shown on an X-axis 1504. In one embodiment of the present invention, a user is provided with a graph similar to the graph 1500, and is allowed to input a line or a curve to specify whether linear or non-linear penalty is to be applied to selected parameters, and what the penalty should be for the selected parameters. For example, graph 1500 includes specified penalty for two particular parameters. The first parameter is shown by parabola 1506. The penalty provided by parabola 1506 is to be applied to routing solutions that vary from specified service point time windows. For example, if a routing solution considers a route that is 60 minutes before a specified time window begins (−60 minutes), then a penalty of approximately 1.25× is to be used. However, if a routing solution considers a route that is 120 minutes before a specified time window begins (−120 minutes), then a penalty of approximately 2× is to be used.

A second parameter specified in graph 1500 applies to configurably weighting of cost associated with time outside an employee's desired work hours. For example, an employee (or a contractor) may desire to work between the hours of 1 pm and 5 pm. However, they may also indicate a willingness to work between 10 am and 8 pm, albeit at increased wages. A line 1508 is shown that indicates the penalty for a particular employee. Line 1508 shows that wages are 1× as long as the routing solution is within his/her desired work hours. However, variation from the desired work hours has the following effect: 2× wages for an hour either side of the desired work hours; 2.5× for 1-3 hours either side of the desired work hours; and 4× for more than 3 hours either side of the desired work hours.

One skilled in the art should appreciate that the parabola 1506, and the line 1508 are exemplary only. That is, the scales used for the Y-axis 1502, and the X-axis 1504 could easily be changed to reflect other requirements. For example, the scale on the Y-axis 1502 could include non-linear linear penalties such as X², X^{2.5}, or X³. In addition, the parameters to which weighting is applied could include any of the parameters described above, but should at least include: a) time outside of specified service point time windows; b) time outside of desired work hours; c) time outside of available work hours; and d) overtime.

Moreover, the user-interface that allows specification of linear and non-linear penalty could be textual rather than graphical. For example, a user could be allowed to enter an equation to be associated with weighting of a specified parameter. For example, an equation for variance from a specified service point time window could be: if tsched<Tstart, 3*(Tstart-tsched)², if tsched>Tend, 3*(tsched-Tend)², where tsched is the time specified for a particular route, and Tstart/Tend are start and end time for a service point time window. While the present invention allows a user to prescribe any equation to be used for selected parameters, it has been determined that the graphical interface shown in FIG. 15 is more readily understood. The manner of prescribing the penalty to be applied to selected parameters is of less interest to the present invention than that both linear and non-linear penalty can be applied, in whatever form, to selected parameters, when determining an optimal routing solution.

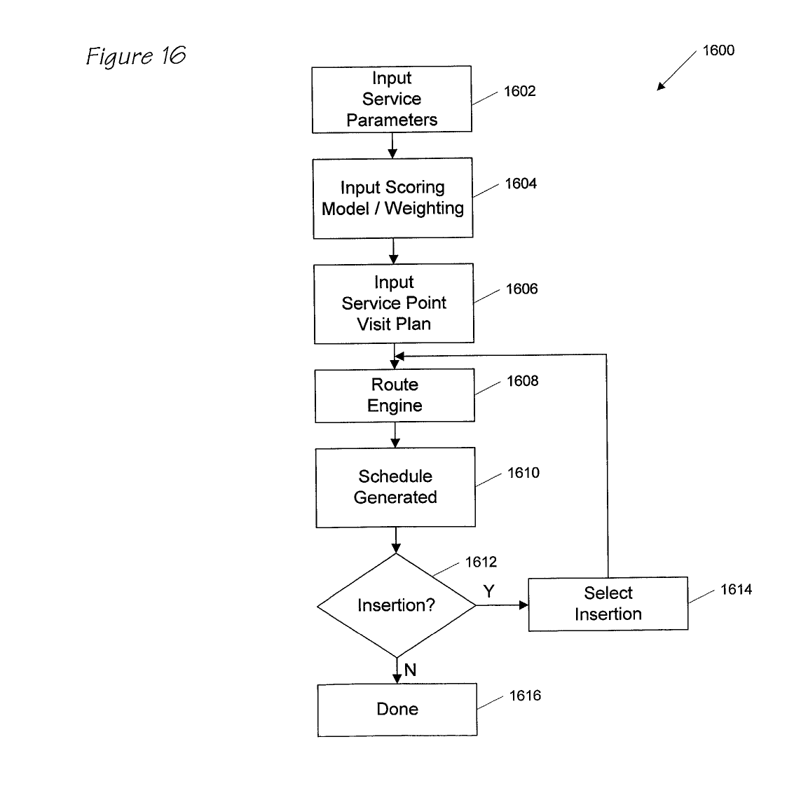

Referring now to FIG. 16, a flow chart 1600 for obtaining an optimal routing solution, according to the present invention, is provided.

Flow begins at block 1602 wherein an operator inputs service parameters. The service parameters that must be input correspond to the parameters within the service point profile and the service provider profile. That is, the service parameters identify all of the service providers and service points, their skills, licenses, preferences, locations, availability, and other requirements. This was described above with reference to FIGS. 5-11, 13. Flow then proceeds to block 1604.

At block 1604, the scoring model is defined for a particular routing solution. That is, costs or weights, linear and non-linear, are applied to selected parameters used in scoring routing solutions. This was described above with reference to FIG. 14. Flow then proceeds to block 1606.

At block 1606, a service point visit plan is created for each of the service points. This was described above with reference to FIG. 12. Flow then proceeds to block 1608.

At block 1608, the service point profiles, the service provider profiles, the visit plans, and the scoring model are provided to a route engine, such as the route engine 420. As described above with reference to FIG. 4, a number of alternative routing algorithms could be used, combined with the parameter control, penalty and complete operational cost model of the present invention to obtain an optimal routing solution. Flow then proceeds to block 1610.

At block 1610, the route engine 420 provides an optimal routing solution to the user interface 410, as described above. Flow then proceeds to decision block 1612.

At decision block 1612, a determination is made as to whether the user desires to insert a particular service point into the route of a particular service provider. If not, then flow proceeds to block 1616 where the generation of an optimal routing solution is completed.

If an operator desires to insert a particular service point into the route of a particular service provider, flow proceeds to block 1614. At this point, the user selects the visit that is to be moved, and drops this visit into the route of an alternative service provider. Flow then proceeds back to block 1608. The route engine then generates an optimal routing solution, but restricts the operation to the two service providers affected by the insertion.

Although the present invention and its objects, features, and advantages have been described in detail, other embodiments are encompassed by the invention. For example, the embodiment shown above with reference to FIGS. 5-13 was particularly illustrated with reference to the home health care industry. However, one skilled in the art will appreciate that the example used was simply for ease of illustration. Other industries, such as the utility industry (gas, electric, telecommunication), hospital care, or any other service industry where the service providers and service points are heterogeneous are also applicable. In addition, only a subset of skills/licenses were shown for the home health care industry. Any set of parameters, skills, licenses, tasks, etc., for any industry, may be incorporated into the present invention, and may be individually selected, or grouped together, to obtain criteria upon which linear or non-linear scoring is applied. Variations in parameter selection, and scoring will drive the routing optimization according to an operator's particular criteria, and according to his industry.

Those skilled in the art should appreciate that they can readily use the disclosed conception and specific embodiments as a basis for designing or modifying other structures for carrying out the same purposes of the present invention without departing from the spirit and scope of the invention as defined by the appended claims.

We claim:

1. A method for calculating an optimal routing solution given a plurality of service points and a plurality of service providers, the plurality of service providers having a plurality of parameters that are selectably weighted, the method comprising:
a) selecting at least one of the plurality of parameters to weight;
b) specifying a weight to be applied to the selected at least one of the plurality of parameters; and
c) scoring a plurality of routing solutions utilizing the specified weight applied to the at least one of the plurality of parameters.

2. A method for calculating an optimal routing solution given a plurality of service points and a heterogeneous plurality of service providers, the heterogeneous plurality of service providers having a plurality of parameters that are selectably weighted, the method comprising:
a) selecting at least one of the plurality of parameters to weight;
b) specifying a weight to be applied to the selected at least one of the plurality of parameters; and
c) scoring a plurality of routing solutions utilizing the specified weight applied to the at least one of the plurality of parameters.

3. The method for calculating an optimal routing solution, as recited in claim 2 wherein the plurality of parameters comprise:
i) a service provider's start time; and
ii) a service provider's end time.

4. The method for calculating an optimal routing solution, as recited in claim 3 wherein the weight that is applied to the selected at least one of the plurality of parameters controls a cost associated with a routing solution that falls outside of the service provider's start time or end time.

5. The method for calculating an optimal routing solution, as recited in claim 2 wherein the weight that is applied to the selected at least one of the plurality of parameters is non-linear.

6. A method for scheduling routes using heterogeneous service providers to service heterogeneous service points, the service points being geographically dispersed, the service points having a plurality of service point profiles, and the service providers having a plurality of service provider profiles, the method comprising:
a) providing a service point visit plan for at least one of the plurality of service points;
b) specifying a configurable weight to be applied to a selectable parameter within one of the plurality of service provider profiles; and
c) scoring a plurality of routing solutions to service the at least one of the plurality of service points, utilizing the service point profiles, the service provider profiles, and the weighted selectable parameter;
d) wherein an optimal routing solution is obtained from the scored plurality of routing solutions.

7. The method for scheduling routes, as recited in claim 6 wherein the configurable weight is specified using a graphical user interface.

8. The method for scheduling routes, as recited in claim 6 wherein the configurable weight is specified by entering a textual non-linear equation.

9. The method for scheduling routes, as recited in claim 6 wherein the configurable weight allows a non-linear cost to be applied to a routing solution at variance with a service provider profile.

10. The method for scheduling routes, as recited in claim 7 wherein a variance from a service provider profile comprises:
i) scheduling a service provider to visit a service point outside the service provider's designated work hours.

11. The method for scheduling routes, as recited in claim 8 wherein a variance from a service provider profile comprises:
i) scheduling a service provider to visit a service point, causing the service provider to work overtime.

12. The method for scheduling routes, as recited in claim 9 wherein a variance from a service provider profile comprises:
i) scheduling a service provider to visit a service point outside of the service provider's desired work hours.

13. The method for scheduling routes, as recited in claim 6 further comprising:
e) specifying a second configurable weight to be applied to a selectable parameter within one of the plurality of service point profiles; and
f) scoring a plurality of routing solutions to service the at least one of the plurality of service points, utilizing the second configurable weight.

14. The method for scheduling routes, as recited in claim 11 wherein the second configurable weight allows a non-linear cost to be applied to a routing solution at variance with a service point profile.

15. The method for scheduling routes, as recited in claim 14 wherein a variance from a service point profile comprises:
i) scheduling a service provider to visit a service point outside of a service point time window specified in one of the plurality of service point profiles.

16. A method for scheduling routes using heterogeneous service providers to service heterogeneous service points, the service points being geographically dispersed, the method comprising:
a) providing a plurality of service point profiles, corresponding to a plurality of service points;
b) providing a plurality of service provider profiles, corresponding to a plurality of service providers;
c) providing a service point visit plan for at least one of the plurality of service points; and
d) scoring a plurality of routing solutions to service the at least one of the plurality of service points, utilizing the service point profiles and the service provider profiles, the scoring comprising:
(1) assigning a weight to selected parameters within the plurality of service point profiles and within the plurality of service provider profiles;
(2) utilizing a route engine to generate the plurality of routing solutions according to the service point visit plan; and
(3) scoring the plurality of routing solutions utilizing the weighted selected parameters.
e) wherein an optimal routing solution is obtained from the scored plurality of routing solutions.

17. The method for scheduling routes, as recited in claim 16, wherein the weight that is assigned to selected parameters is non-linear.

18. The method for scheduling routes, as recited in claim 16, wherein the weight that is assigned to selected parameters is selectably linear or non-linear.
